(19) United States
(12) Patent Application Publication
(10) Pub. No.: US 2021/0332183 A1
(43) Pub. Date: Oct. 28, 2021

(54) PROCESS FOR PRODUCING A POLYESTER

(71) Applicant: Covestro Intellectual Property GmbH & Co. KG, Leverkusen (DE)

(72) Inventors: Martin Machat, Köln (DE); Aurel Wolf, Wülfrath (DE); Christoph Guertler, Köln (DE); Markus Meuresch, Köln (DE)

(21) Appl. No.: 17/312,574

(22) PCT Filed: Dec. 16, 2019
(86) PCT No.: PCT/EP2019/085304

§ 371 Date: Jun. 10, 2021

(30) Foreign Application Priority Data
Dec. 21, 2018 (EP) 18215186.0

(51) Int. Cl. C08G 63/08; C08G 63/82; C09D 167/04; C09J 167/04

(52) U.S. Cl. CPC C08G 63/08; C09J 167/04; C09D 167/04; C08G 63/823

(57) ABSTRACT

The invention relates to a process for producing a polyester by reacting a H-functional starter substance with a lactone in the presence of a catalyst, wherein the H-functional compound has one or more free carboxyl groups, wherein the lactone is a four-membered ring lactone, and wherein the catalyst is a Brönsted acid or a double metal cyanide (DMC) catalyst. The invention also relates to the polyester that can be obtained by the present invention.

The invention provides a process for preparing a polyester by reaction of an H-functional starter substance with a lactone in the presence of a catalyst, wherein the H-functional compound has one or more free carboxyl groups, wherein the lactone is a 4-membered-ring lactone, and wherein the catalyst is a Brønsted acid or a double metal cyanide (DMC) catalyst. The invention further provides the polyester obtainable in accordance with the present invention.

WO 2011/000560 A1 discloses a process for preparing polyether ester polyols having primary hydroxyl end groups, comprising the steps of reacting a starter substance comprising active hydrogen atoms with an epoxide under double metal cyanide catalysis, reacting the obtained product with a cyclic carboxylic anhydride and reacting this obtained product with ethylene oxide in the presence of a catalyst comprising at least one nitrogen atom per molecule with the exception of acyclic, identically substituted tertiary amines. The resulting polyether ester polyols from this multistage process have a proportion of primary hydroxyl groups of at most 76%.

WO2008/104723 A1 discloses a process for preparing a polylactone or polylactam, wherein the lactone or lactam is reacted with an H-functional starter substance in the presence of a non-chlorinated aromatic solvent and a sulfonic acid on a microliter scale. Employed here as the H-functional starter substance are low molecular weight monofunctional or polyfunctional alcohols or thiols, wherein the working examples disclose (monofunctional) n-pentanol with ε-caprolactone or δ-valerolactone in the presence of large amounts of trifluoromethanesulfonic acid of 2.5 mol % or more.

Couffin et al. Poly. Chem 2014, 5, 161 disclose a selective O-acyl opening of β-butyrolactone with H-functional starter substances such as for example n-pentanol, butane-1,4-diol and polyethylene glycol in deuterated benzene and in the presence of trifluoromethanesulfonic acid in a batch mode. Here, the reactions are performed on a microliter scale and large amounts of the acid catalyst of 2.5 mol % or more based on the amount of employed lactone are used.

GB1201909 likewise discloses a process for preparing polyester by reaction of a lactone with an H-functional starter substance in the presence of an organic carboxylic acid or sulfonic acid having a pKa at 25° C. of less than 2.0. Here, all reaction components such as short-chain alcohols and ε-caprolactone or mixtures of isomeric methyl-ε-caprolactone were initially charged in large amounts of trichloro- or trifluoroacetic acid catalyst and reacted in a batch process for at least 20 hours, resulting in solids or liquid products having a broad molar mass distribution.

U.S. Pat. No. 5,032,671 discloses a process for preparing polymeric lactones by reaction of an H-functional starter substance and lactones in the presence of a double metal cyanide (DMC) catalyst. In this respect, the working examples disclose the reaction of polyether polyols with ε-caprolactone, δ-valerolactone or β-propiolactone to afford polyether-polyester polyol block copolymers, wherein these reactions are performed in the presence of large amounts of 980 ppm to 1000 ppm of the cobalt-containing DMC catalyst and in the presence of organic solvents, wherein the resulting products have a broad molar mass distribution of 1.32 to 1.72. For the reaction of the polyether polyol with β-propiolactone, only the formation of a resulting polyester with a molar mass of 10 000 g/mol is postulated. This process further requires a workup step wherein the products are filtered through diatomaceous earth and the solvent is subsequently removed.

Proceeding from the prior art, it was an object of the present invention to improve and to simplify the process for the preparation of polyesters with respect to the formation of a defined, homogeneous reaction product with incorporation of all reaction components, wherein the resulting polyester also has a narrow molar mass distribution with a polydispersity index of preferably less than or equal to 1.15.

It has been found, surprisingly, that the object according to the invention is achieved by a process for preparing a polyester by reaction of an H-functional starter substance with a lactone in the presence of a catalyst, wherein the H-functional compound has one or more free carboxyl groups, wherein the lactone is a 4-membered-ring lactone, and wherein the catalyst is a Brønsted acid or a double metal cyanide (DMC) catalyst.

In the process according to the invention, an H-functional compound is used, wherein the H-functional compound has one or more carboxyl groups, preferably 1 to 8 and particularly preferably 2 to 6.

In one embodiment of the process according to the invention, the H-functional compound has no free primary and/or secondary hydroxyl groups.

In one embodiment of the process according to the invention, the H-functional starter substance having one or more free carboxyl groups is one or more compounds and is selected from the group consisting of monobasic carboxylic acids, polybasic carboxylic acids, carboxyl-terminated polyesters, carboxyl-terminated polycarbonates, carboxyl-terminated polyether carbonates, carboxyl-terminated polyether ester carbonate polyols and carboxyl-terminated polyethers.

Suitable monobasic carboxylic acids include monobasic C1 to C20 carboxylic acids such as for example methanoic acid, ethanoic acid, propanoic acid, butanoic acid, pentanoic acid, hexanoic acid, heptanoic acid, octanoic acid, decanoic acid, dodecanoic acid, tetradecanoic acid, hexadecanoic acid, octadecanoic acid, lactic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid, benzoic acid, acrylic acid and methacrylic acid.

Suitable polybasic carboxylic acids include polybasic C1 to C20 carboxylic acids such as for example oxalic acid, malonic acid, succinic acid, glutaric acid, adipic acid, pimelic acid, suberic acid, azelaic acid, sebacic acid, citric acid, trimesic acid, fumaric acid, maleic acid, 1,10-decanedicarboxylic acid, 1,12-dodecanedicarboxylic acid, phthalic acid, isophthalic acid, terephthalic acid, pyromellitic acid and trimellitic acid.

The H-functional starter substances may also be selected from the substance class of the carboxyl-terminated polyesters, especially those having a molecular weight Mn in the range from 50 to 4500 g/mol. Polyesters used may be at least difunctional polyesters. Polyesters preferably consist of alternating acid and alcohol units. Examples of acid components used may be succinic acid, maleic acid, adipic acid, phthalic acid, isophthalic acid, terephthalic acid, tetrahydrophthalic acid. The resulting polyesters have terminal carboxyl groups.

It is preferable to obtain carboxyl-terminated polycarbonates for example by reaction of polycarbonate polyols, preferably polycarbonate diols, with stoichiometric addition or stoichiometric excess, preferably stoichiometric excess, of polybasic carboxylic acids and/or cyclic anhydrides.

The polycarbonate diols especially have a molecular weight Mn in the range from 1000 to 4500 g/mol, preferably 1500 to 2500 g/mol, wherein the polycarbonate diols are prepared for example by reaction of phosgene, dimethyl carbonate, diethyl carbonate or diphenyl carbonate and difunctional alcohols or polyester polyols or polyether polyols. Examples for polycarbonates are found, for example, in EP-A 1359177. Polycarbonate diols that may be used include for example the Desmophen® C line from Covestro AG, for example Desmophen® C 1100 or Desmophen® C 2200. Cyclic anhydrides include for example maleic anhydride, succinic anhydride, methylsuccinic anhydride, phthalic anhydride, tetrahydrophthalic anhydride and hexahydrophthalic anhydride.

It is preferable to obtain carboxyl-terminated polyether carbonates and/or polyether ester carbonates for example by reaction of polyether carbonate polyols and/or polyether ester carbonate polyols with stoichiometric addition or stoichiometric excess, preferably stoichiometric excess, of polybasic carboxylic acids and/or cyclic anhydrides. Polyether carbonate polyols (for example Cardyon® polyols from Covestro), polycarbonate polyols (for example Converge® polyols from Novomer/Saudi Aramco, NEOSPOL polyols from Repsol etc.) and/or polyether ester carbonate polyols are used. In particular, polyether carbonate polyols, polycarbonate polyols and/or polyether ester carbonate polyols may be obtained by reaction of alkylene oxides, preferably ethylene oxide, propylene oxide or mixtures thereof, optionally further comonomers, with CO2 in the presence of a further H-functional starter substance and using catalysts. These catalysts include double metal cyanide catalysts (DMC catalysts) and/or metal complex catalysts for example based on the metals zinc and/or cobalt, for example zinc glutarate catalysts (described for example in M. H. Chisholm et al., Macromolecules 2002, 35, 6494), so-called zinc diiminate catalysts (described for example in S. D. Allen, J. Am. Chem. Soc. 2002, 124, 14284) and so-called cobalt salen catalysts (described for example in U.S. Pat. No. 7,304,172 B2, US 2012/0165549 A1) and/or manganese salen complexes. An overview of the known catalysts for the copolymerization of alkylene oxides and CO2 may be found for example in Chemical Communications 47 (2011) 141-163. The use of different catalyst systems, reaction conditions and/or reaction sequences results in this respect in the formation of random, alternating, block-type or gradient-type polyether carbonate polyols, polycarbonate polyols and/or polyether ester carbonate polyols. To this end, these polyether carbonate polyols, polycarbonate polyols and/or polyether ester carbonate polyols used as H-functional starter substances may be prepared beforehand in a separate reaction step. Cyclic anhydrides include for example maleic anhydride, succinic anhydride, methylsuccinic anhydride, phthalic anhydride, tetrahydrophthalic anhydride and hexahydrophthalic anhydride.

It is preferable to obtain carboxyl-terminated polyethers for example by reaction of polyether polyols with stoichiometric addition or stoichiometric excess, preferably stoichiometric excess, of polybasic carboxylic acids and/or cyclic anhydrides. The polyether polyols constructed from repeating ethylene oxide and propylene oxide units, preferably having a proportion of propylene oxide units of 50% to 100%, particularly preferably having a proportion of propylene oxide units of 80% to 100%. These may be random copolymers, gradient copolymers, alternating copolymers or block copolymers of ethylene oxide and propylene oxide. Suitable polyether polyols constructed from repeating propylene oxide and/or ethylene oxide units are for example the Desmophen®, Acclaim®, Arcol®, Baycoll®, Bayfill®, Bayflex®, Baygal®, PET® and polyether polyols from Covestro AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are for example the Pluriol® E products from BASF SE, suitable homopolypropylene oxides are for example the Pluriol® P products from BASF SE, suitable mixed copolymers of ethylene oxide and propylene oxide are for example the Pluronic® PE or Pluriol® RPE products from BASF SE. Cyclic anhydrides include for example maleic anhydride, succinic anhydride, methylsuccinic anhydride, phthalic anhydride, tetrahydrophthalic anhydride and hexahydrophthalic anhydride.

In one embodiment of the process according to the invention, the H-functional starter substance having one or more free carboxyl groups is one or more compounds and is selected from the group consisting of methanoic acid, ethanoic acid, propanoic acid, butanoic acid, pentanoic acid, hexanoic acid, heptanoic acid, octanoic acid, decanoic acid, dodecanoic acid, tetradecanoic acid, hexadecanoic acid, octadecanoic acid, lactic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid, benzoic acid, oxalic acid, malonic acid, succinic acid, glutaric acid, adipic acid, pimelic acid, suberic acid, azelaic acid, sebacic acid, citric acid, trimesic acid, fumaric acid, maleic acid, 1,10-decanedicarboxylic acid, 1,12-dodecanedicarboxylic acid, phthalic acid, isophthalic acid, terephthalic acid, pyromellitic acid and trimellitic acid, acrylic acid and methacrylic acid.

According to the technical generally valid understanding in organic chemistry, lactones are to be understood as meaning heterocyclic compounds, wherein lactones are formed by intramolecular esterification, i.e. the reaction of a hydroxyl functionality with a carboxyl functionality in a hydroxycarboxylic acid. They are therefore cyclic esters having a ring oxygen.

In one embodiment of the process according to the invention, the lactone is a 4-membered-ring lactone, wherein the 4-membered-ring lactone is one or more compounds and is selected from the group consisting of propiolactone, β-butyrolactone, diketene, preferably propiolactone and β-butyrolactone.

In one embodiment of the process according to the invention, the catalyst is a double metal cyanide (DMC) catalyst.

The DMC catalysts which can be used with preference in the process according to the invention contain double metal cyanide compounds which are the reaction products of water-soluble metal salts and water-soluble metal cyanide salts.

Double metal cyanide (DMC) catalysts for use in the homopolymerization of alkylene oxides are known in principle from the prior art (see, for example, U.S. Pat. Nos. 3,404,109, 3,829,505, 3,941,849 and 5,158,922). DMC catalysts described, for example, in U.S. Pat. No. 5,470,813, EP-A 700 949, EP-A 743 093, EP-A 761 708, WO 97/40086, WO 98/16310 and WO 00/47649 have a very high activity and enable the preparation of polyoxyalkylene polyols at very low catalyst concentrations. A typical example is that of the highly active DMC catalysts described in EP-A 700 949 which, as well as a double metal cyanide compound (e.g. zinc hexacyanocobaltate(III)) and an organic complex ligand (e.g. tert-butanol), also contain a polyether having a number-average molecular weight greater than 500 g/mol.

The DMC catalysts which can be used in accordance with the invention are preferably obtained by

(1.) in a first step, reacting an aqueous solution of a metal salt with the aqueous solution of a metal cyanide salt in the presence of one or more organic complex ligands, e.g. an ether or alcohol,

(2.) in a second step, using known techniques (such as centrifugation or filtration) to remove the solid from the suspension obtained from (1.),

(3.) optionally, in a third step, washing the isolated solid with an aqueous solution of an organic complex ligand (for example by resuspension and subsequent reisolation by filtration or centrifugation),

(4.) and subsequently drying the solid obtained, optionally after pulverizing, at temperatures of in general 20-120° C. and at pressures of in general 0.1 mbar to standard pressure (1013 mbar),

and wherein, in the first step or immediately after the precipitation of the double metal cyanide compound (second step), one or more organic complex ligands, preferably in excess (based on the double metal cyanide compound), and optionally further complex-forming components are added.

The double metal cyanide compounds present in the DMC catalysts which can be used in accordance with the invention are the reaction products of water-soluble metal salts and water-soluble metal cyanide salts.

By way of example, an aqueous zinc chloride solution (preferably in excess relative to the metal cyanide salt) and potassium hexacyanocobaltate are mixed and then dimethoxyethane (glyme) or tert-butanol (preferably in excess, relative to zinc hexacyanocobaltate) is added to the resulting suspension.

Metal salts suitable for preparing the double metal cyanide compounds preferably have a composition according to the general formula (I),

M(X)n (I),

where

M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,

X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

n is 1 if X=sulfate, carbonate or oxalate and

n is 2 if X=halide, hydroxide, carboxylate, cyanate, thiocyanate, isocyanate, isothiocyanate or nitrate,

or suitable metal salts preferably have a composition according to the general formula (II)

Mr(X)3 (II),

where

M is selected from the metal cations Fe³⁺, Al³⁺, Co³⁺ and Cr³⁺,

X comprises one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

r is 2 if X=sulfate, carbonate or oxalate and

r is 1 if X=halide, hydroxide, carboxylate, cyanate, thiocyanate, isocyanate, isothiocyanate or nitrate,

or suitable metal salts preferably have a composition according to the general formula (III)

M(X)s (III),

where

M is selected from the metal cations Mo⁴⁺, V⁴⁺ and W⁴⁺,

X comprises one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;

s is 2 if X=sulfate, carbonate or oxalate and

s is 4 if X=halide, hydroxide, carboxylate, cyanate, thiocyanate, isocyanate, isothiocyanate or nitrate,

or suitable metal salts preferably have a composition according to the general formula (IV)

M(X)t (IV),

where

M is selected from the metal cations Mo⁶⁺ and W⁶⁺,

X comprises one or more (i.e. different) anions, preferably anions selected from the group of halides (i.e. fluoride, chloride, bromide, iodide), hydroxide, sulfate, carbonate, cyanate, thiocyanate, isocyanate, isothiocyanate, carboxylate, oxalate and nitrate;

t is 3 if X=sulfate, carbonate or oxalate and

t is 6 if X=halide, hydroxide, carboxylate, cyanate, thiocyanate, isocyanate, isothiocyanate or nitrate. Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparing the double metal cyanide compounds preferably have a composition according to the general formula (V)

(Y)aM′(CN)b(A)c (V),

where

M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),

Y is selected from one or more metal cations from the group consisting of alkali metal (i.e. Li⁺, Na⁺, K⁺, Rb⁺) and alkaline earth metal (i.e. Be²⁺, Mg²⁺, Ca²⁺, Sr²⁺, Ba²⁺),

A is selected from one or more anions from the group consisting of halides (i.e. fluoride, chloride, bromide, iodide), hydroxide, sulfate, carbonate, cyanate, thiocyanate, isocyanate, isothiocyanate, carboxylate, azide, oxalate or nitrate, and

a, b and c are integers, wherein the values for a, b and c are selected such as to ensure the electronic neutrality of the metal cyanide salt; a is preferably 1, 2, 3 or 4; b is preferably 4, 5 or 6; c preferably has the value 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds present in the DMC catalysts which can be used in accordance with the invention are compounds having compositions according to the general formula (VI)

Mx[M′x,(CN)y]z (VI),

in which M is defined as in the formulae (I) to (IV) and

M′ is as defined in formula (V), and

x, x′, y and z are integers and are selected such as to ensure the electronic neutrality of the double metal cyanide compound.

Preferably,

x=3, x′=1, y=6 and z=2,

M=Zn(II), Fe(II), Co(II) or Ni(II) and

M′=Co(III), Fe(III), Cr(III) or Ir(III).

Examples of suitable double metal cyanide compounds (VI) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). With particular preference it is possible to use zinc hexacyanocobaltate(III). The organic complex ligands which can be added in the preparation of the DMC catalysts are disclosed in, for example, U.S. Pat. No. 5,158,922 (see, in particular, column 6, lines 9 to 65), U.S. Pat. Nos. 3,404,109, 3,829,505, 3,941,849, EP-A 700 949, EP-A 761 708, JP 4 145 123, U.S. Pat. No. 5,470,813, EP-A 743 093 and WO-A 97/40086). For example, organic complex ligands used are water-soluble organic compounds having heteroatoms, such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds which include both aliphatic or cycloaliphatic ether groups and aliphatic hydroxyl groups (such as ethylene glycol mono-tert-butyl ether, diethylene glycol mono-tert-butyl ether, tripropylene glycol monomethyl ether and 3-methyl-3-oxetanemethanol, for example). Extremely preferred organic complex ligands are selected from one or more compounds of the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol. In the preparation of the DMC catalysts which can be used in accordance with the invention, there is optional use of one or more complex-forming components from the compound classes of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid copolymers and maleic anhydride copolymers, hydroxyethylcellulose and polyacetals, or of the glycidyl ethers, glycosides, carboxylic esters of polyhydric alcohols, bile acids or salts, esters or amides thereof, cyclodextrins, phosphorus compounds, α,β-unsaturated carboxylic esters, or ionic surface-active or interface-active compounds.

In the preparation of the DMC catalysts which can be used in accordance with the invention, preference is given to using the aqueous solutions of the metal salt (e.g. zinc chloride) in the first step in a stoichiometric excess (at least 50 mol %) relative to the metal cyanide salt. This corresponds to at least a molar ratio of metal salt to metal cyanide salt of 2.25:1.00. The metal cyanide salt (e.g. potassium hexacyanocobaltate) is reacted in the presence of the organic complex ligand (e.g. tert-butanol), and a suspension is formed which comprises the double metal cyanide compound (e.g. zinc hexacyanocobaltate), water, excess metal salt, and the organic complex ligand.

The organic complex ligand may be present here in the aqueous solution of the metal salt and/or the metal cyanide salt, or it is added directly to the suspension obtained after precipitation of the double metal cyanide compound. It has proven to be advantageous to mix the metal salt and metal cyanide salt aqueous solutions and the organic complex ligand by stirring vigorously. Optionally, the suspension formed in the first step is subsequently treated with a further complex-forming component. The complex-forming component is preferably used in a mixture with water and organic complex ligand here. A preferred process for performing the first step (i.e. the preparation of the suspension) is effected using a mixing nozzle, particularly preferably using a jet disperser, as described, for example, in WO-A 01/39883.

In the second step, the solid (i.e. the precursor of the catalyst) can be isolated from the suspension by known techniques, such as centrifugation or filtration.

In a preferred variant of the embodiment, the isolated solid is then washed with an aqueous solution of the organic complex ligand (for example by resuspension and subsequent reisolation by filtration or centrifugation) in a third process step. In this way, for example, water-soluble by-products, such as potassium chloride, can be removed from the catalyst which can be used in accordance with the invention. Preferably, the amount of the organic complex ligand in the aqueous wash solution is between 40% and 80% by weight, based on the overall solution.

Optionally, in the third step, the aqueous wash solution is admixed with a further complex-forming component, preferably in the range between 0.5% and 5% by weight, based on the overall solution. It is also advantageous to wash the isolated solid more than once. Preferably, in a first wash step, an aqueous solution of the organic complex ligand is used for washing (for example by resuspension and subsequent reisolation by filtration or centrifugation), in order in this way to remove, for example, water-soluble by-products such as potassium chloride from the catalyst which can be used in accordance with the invention. It is particularly preferable when the amount of the organic complex ligand in the aqueous wash solution is between 40% and 80% by weight based on the overall solution for the first wash step. In the further wash steps, either the first wash step is repeated once or more than once, preferably once to three times, or, preferably, a nonaqueous solution, for example a mixture or solution of organic complex ligands and further complex-forming component (preferably in the range between 0.5% and 5% by weight, based on the total amount of the wash solution in the step), is used as a wash solution to wash the solid once or more than once, preferably once to three times.

The isolated and optionally washed solid can then be dried, optionally after pulverization, at temperatures of 20-100° C. and at pressures of 0.1 mbar to standard pressure (1013 mbar).

One preferred method for isolating the DMC catalysts which can be used in accordance with the invention from the suspension by filtration, filtercake washing and drying is described in WO-A 01/80994.

In one embodiment of the process according to the invention, the double metal cyanide catalyst comprises an organic complex ligand, wherein the organic complex ligand is one or more compounds and is selected from the group consisting of tert-butanol, 2-methyl-3-buten-2-ol, 2-methyl-3-butyn-2-ol, ethylene glycol mono-tert-butyl ether and 3-methyl-3-oxetanemethanol.

In one embodiment of the process according to the invention, the double metal cyanide (DMC) catalyst is used in an amount of 20 ppm to 5000 ppm, preferably 50 ppm to 4000 ppm, based on polyester formed.

In a further embodiment of the process according to the invention, the catalyst is a Brønsted acid.

In line with the customary definition in the art, Brønsted acids are to be understood as meaning substances capable of transferring protons to a second reaction partner, the so-called Brønsted base, typically in an aqueous medium at 25° C. In the context of the present invention, the term “Brønsted-acidic catalyst” is to be understood as meaning a non-polymeric compound, wherein the Brønsted-acidic catalyst has a calculated molar mass of ≤1200 g/mol, preferably of ≤1000 g/mol and particularly preferably of ≤850 g/mol.

In one embodiment of the process according to the invention, the Brønsted-acidic catalyst has a pKa of less than or equal to 1, preferably of less than or equal to 0.

In one embodiment of the process according to the invention, the Brønsted-acidic catalyst is one or more compounds and is selected from the group consisting of aliphatic fluorinated sulfonic acids, aromatic fluorinated sulfonic acids, trifluoromethanesulfonic acid, perchloric acid, hydrochloric acid, hydrobromic acid, hydroiodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, methanesulfonic acid, paratoluenesulfonic acid, aromatic sulfonic acids and aliphatic sulfonic acids, preferably from trifluoromethanesulfonic acid, perchloric acid, hydrochloric acid, hydrobromic acid, hydroiodic acid, fluorosulfonic acid, bis(trifluoromethane)sulfonimide, hexafluoroantimonic acid, pentacyanocyclopentadiene, picric acid, sulfuric acid, nitric acid, trifluoroacetic acid, methanesulfonic acid, methanesulfonic acid and paratoluenesulfonic acid, particularly preferably from trifluoromethanesulfonic acid, perchloric acid, hydrochloric acid, hydrobromic acid, hydroiodic acid, bis(trifluoromethane)sulfonimide, pentacyanocyclopentadiene, sulfuric acid, nitric acid and trifluoroacetic acid.

In one embodiment of the process according to the invention, the Brønsted-acidic catalyst is used in an amount of 0.001 mol % to 0.5 mol %, preferably of 0.003 to 0.4 mol % and particularly preferably of 0.005 to 0.3 mol %, based on the amount of lactone.

In line with the customary definition in the art, a solvent is to be understood as meaning one or more compounds which dissolve the lactone or the H-functional starter substance and/or the Brønsted-acidic catalyst but without themselves reacting with the lactone, the H-functional starter substance and/or the Brønsted-acidic catalyst.

In one embodiment of the process according to the invention, the polyesters are prepared in the presence of an aprotic solvent such as for example toluene, benzene, tetrahydrofuran, dimethyl ether and diethyl ether.

In a preferred embodiment, the process according to the invention is performed without addition of a solvent and there is therefore no need to remove this solvent in an additional process step after the preparation of the polyester.

In one embodiment of the process according to the invention, the H-functional starter substance is reacted with the lactone in the presence of the Brønsted-acidic catalyst at temperatures of 20 to 150° C., preferably of 20 to 100° C. Below 20° C., only insignificant, if any, reaction to afford the product according to the invention takes place and above 150° C. decomposition of the polyester formed and/or undesired parallel or further reactions take place.

In one embodiment of the process according to the invention, the H-functional starter substance is reacted with the lactone in the presence of the double metal cyanide (DMC) catalyst at temperatures of 70 to 150° C., preferably of 90 to 130° C. Below 70° C., only insignificant, if any, reaction to afford the product according to the invention takes place and above 150° C. decomposition of the polyester formed and/or undesired secondary or subsequent reactions take place.

In one embodiment, the process according to the invention comprises the following steps:
i) initially charging the H-functional starter substance and optionally the catalyst to form a mixture i);
ii) adding the lactone to the mixture i).

In one embodiment of the process according to the invention, the lactone is added continuously or stepwise to the H-functional starter substance in step ii) and reacted to afford the polyester (semi-batch mode).

In the process according to the invention, continuous addition of the lactone is to be understood as meaning a volume flow of the lactone of >0 ml/min, wherein the volume flow may be constant or may vary during this step (continuous lactone addition).

In an alternative embodiment of the process according to the invention, the lactone is added stepwise to the mixture i) in step ii) and then reacted to afford the polyester (stepwise lactone addition).

In the process according to the invention, stepwise addition of the lactone is to be understood as meaning at least the addition of the entire lactone amount in two or more discrete portions of the lactone, wherein the volume flow of the lactone between the two or more discrete portions is 0 ml/min and wherein the volume flow of the lactone during a discrete portion may be constant or varies but is >0 ml/min.

In an alternative embodiment, the process according to the invention comprises the following steps:

(a) initially charging the H-functional starter substance, the lactone and optionally the catalyst to form a mixture (a);

(b) reacting the mixture (a) to afford the polyester,

this corresponding to a batchwise process regime.

In a further alternative embodiment, the process according to the invention comprises the following steps:
i) initially charging the catalyst;
ii) adding the lactone and the H-functional starter substance to the catalyst.

In this case, the lactone and the H-functional starter substance may be premixed or the lactone and the H-functional starter substance are added to the reactor via separate feeds. This corresponds to a CAOS (Continuous Addition of Starter) mode.

In a further, alternative embodiment, the H-functional starter substance, the lactone and the catalyst are continuously mixed and reacted together while continuously discharging the polyester product, wherein the reaction is performed for example in a tubular reactor or a continuous stirred tank reactor or combinations of these two reaction apparatuses, this corresponding to a fully continuous preparation process for the polyester.

The present invention further provides polyesters obtainable by the process according to the invention.

In one embodiment, the polyester according to the invention has a polydispersity index of ≤1.15, preferably ≤1.10, wherein the polydispersity index has been determined by means of gel permeation chromatography as disclosed in the description.

In one embodiment, the polyester according to the invention has a number-average molecular weight of 70 g/mol to 15 000 g/mol, preferably of 70 g/mol to 10 000 g/mol and particularly preferably of 80 g/mol to 5000 g/mol, wherein the number-average molecular weight is determined by means of gel permeation chromatography (GPC) as disclosed in the experimental section.

A further embodiment of the present invention relates to coating compositions or adhesive compositions containing the polyesters according to the invention.

In a further embodiment of the invention, the polyester according to the invention is used in coatings or adhesives.

A further embodiment of the present invention comprises a process for reacting the polyester according to the invention with compounds comprising carboxyl-reactive compounds such as for example alkylene oxides, alcohols, amines.

In a first embodiment, the invention relates to a process for preparing a polyester by reaction of an H-functional starter substance with a lactone in the presence of a catalyst, wherein the H-functional compound has one or more free carboxyl groups, wherein the lactone is a 4-membered-ring lactone, and wherein the catalyst is a Brønsted acid or a double metal cyanide (DMC) catalyst.

In a second embodiment, the invention relates to a process according to the first embodiment, wherein the lactone is a 4-membered-ring lactone and the 4-membered-ring lactone is one or more compounds and is selected from the group consisting of propiolactone, β-butyrolactone, diketene, preferably propiolactone and β-butyrolactone.

In a third embodiment, the invention relates to a process according to the first or second embodiment, comprising the following steps:

i) initially charging the H-functional starter substance and optionally the catalyst to form a mixture i);

ii) adding the lactone to the mixture i).

In a fourth embodiment, the invention relates to a process according to the third embodiment, wherein the lactone is added continuously or stepwise to the mixture i) in step ii).

In a fifth embodiment, the invention relates to a process according to the first or second embodiment, comprising the following steps:

(a) initially charging the H-functional starter substance, the lactone and optionally the catalyst to form a mixture (a);

(b) reacting the mixture (a) to afford the polyester.

In a sixth embodiment, the invention relates to a process according to any of the first to fifth embodiments, wherein the H-functional starter substance having one or more free carboxyl groups is one or more compounds and is selected from the group consisting of monobasic carboxylic acids, polybasic carboxylic acids, carboxyl-terminated polyesters, carboxyl-terminated polycarbonates, carboxyl-terminated polyether carbonates, carboxyl-terminated polyether ester carbonate polyols and carboxyl-terminated polyethers.

In a seventh embodiment, the invention relates to a process according to any of the first to sixth embodiments, wherein the H-functional starter substance having one or more free carboxyl groups is one or more compounds and is selected from the group consisting of methanoic acid, ethanoic acid, propanoic acid, butanoic acid, pentanoic acid, hexanoic acid, heptanoic acid, octanoic acid, decanoic acid, dodecanoic acid, tetradecanoic acid, hexadecanoic acid, octadecanoic acid, lactic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid, benzoic acid, oxalic acid, malonic acid, succinic acid, glutaric acid, adipic acid, pimelic acid, suberic acid, azelaic acid, sebacic acid, citric acid, trimesic acid, fumaric acid, maleic acid, 1,10-decanedicarboxylic acid, 1,12-dodecanedicarboxylic acid, phthalic acid, isophthalic acid, terephthalic acid, pyromellitic acid and trimellitic acid, acrylic acid and methacrylic acid.

In an eighth embodiment, the invention relates to a process according to any of the first to seventh embodiments, wherein the catalyst is a double metal cyanide (DMC) catalyst.

In a ninth embodiment, the invention relates to a process according to the eighth embodiment, wherein the double metal cyanide (DMC) catalyst comprises an organic complex ligand, wherein the organic complex ligand is one or more compounds and is selected from the group consisting of tert-butanol, 2-methyl-3-buten-2-ol, 2-methyl-3-butyn-2-ol, ethylene glycol mono-tert-butyl ether and 3-methyl-3-oxetanemethanol.

In a tenth embodiment, the invention relates to a process according to any of the first to ninth embodiments, wherein the process is performed without addition of a solvent.

In an eleventh embodiment, the invention relates to a process according to any of the first to tenth embodiments, wherein the molar ratio of the lactone to the H-functional starter substance is from 1:1 to 30:1, preferably from 1:1 to 20:1.

In a twelfth embodiment, the invention relates to a polyester obtainable in accordance with at least one of the first to eleventh embodiments.

In a thirteenth embodiment, the invention relates to a polyester according to the twelfth embodiment, wherein the polyester has a polydispersity index of ≤1.15, preferably ≤1.10, wherein the polydispersity index has been determined by means of gel permeation chromatography as disclosed in the description.

In a fourteenth embodiment, the invention relates to coating compositions or adhesive compositions containing polyesters according to the twelfth or thirteenth embodiment.

In a fifteenth embodiment, the invention relates to a process according to any of the first, second and sixth to eleventh embodiments, comprising the following steps:

i) initially charging the catalyst;

ii) adding the lactone and the H-functional starter substance to the catalyst.

In a sixteenth embodiment, the invention relates to a process according to the fifteenth embodiment, wherein the lactone and the H-functional starter substance are premixed or the lactone and the H-functional starter substance are added to the reactor via separate feeds.

In a seventeenth embodiment, the invention relates to a process according to any of the first, second and sixth to eleventh embodiments, wherein the H-functional starter substance, the lactone and the catalyst are continuously mixed and reacted to afford the polyester product and the polyester product is continuously discharged.

### EXAMPLES

The present invention is more particularly elucidated with reference to the following examples without, however, being limited thereto.

### Starting Materials Used

### Cyclic Lactones

β-Propiolactone (bPL, purity 98.5%, Ferak Berlin GmbH)

β-Butyrolactone (bBL, purity 98%, Sigma-Aldrich Chemie GmbH)

### H-Functional Starter Substance

Octane-1,8-diol (98%, Sigma Aldrich)

Adipic acid (Sigma-Aldrich, BioXtra, 99.5% (HPLC))

Citric acid (anhydrous, Sigma Aldrich, 99.5%)

Terephthalic acid (Sigma Aldrich, 98%)

### Catalysts

All examples employed a DMC catalyst produced according to example 6 in WO 01/80994 A1.

### Solvent

Toluene (>99.5%, Azelis Deutschland GmbH)

THF (Fisher Scientific, GPC grade)

### Description of the Methods

Gel permeation chromatography (GPC): Measurements were performed on an Agilent 1200 Series (G1311A Bin Pump, G1313A ALS, G1362A RID), detection by RID; eluent: tetrahydrofuran (GPC grade), flow rate 1.0 ml/min at 40° C. column temperature; column combination: 2×PSS SDV precolumn 100 Å (5 μm), 2×PSS SDV 1000 Å (5 μm). Calibration was carried out using ReadyCal Kit Poly(styrene) low in the range Mp=266-66 000 Da from “PSS Polymer Standards Service”. The measurement recording and evaluation software used was the “PSS WinGPC Unity” software package. The polydispersity index from weighted (Mw) and number-average (Mn) molecular weight from the gel permeation chromatography is defined as Mw/Mn.

### ¹H NMR

The conversion of the monomer was determined by ¹H NMR (Bruker DPX 400, 400 MHz; pulse program zg30, relaxation delay D1: 10 s, 64 scans). Each sample was dissolved in deuterated chloroform. The relevant resonances in the ¹H NMR (relative to TMS=0 ppm) and the assignment of the area integrals (A) are as follows:
poly(hydroxybutyrate) (=polybutyrolactone) with resonances at 5.25 (1H), 2.61 (1H), 2.48 (1H) and 1.28 (3H).
β-butyrolactone with resonances at 4.70 (1H), 3.57 (1H), 3.07 (1H) and 1.57 (3H).
poly(hydroxypropionate) (=polypropiolactone) with resonances at 4.38 (2H) and 2.66 (2H)
β-propiolactone with resonances at 4.28 (2H) and 3.54 (2H)

The conversion is determined as an integral of a suitable polymer signal divided by the sum of a suitable polymer signal and monomer signal. All signals are referenced to 1H.

### Example 1: Preparation of a Polyester from β-Butyrolactone Using DMC Catalysis and Carboxylic Acid-Functionalized Starter (Adipic Acid)

A 300 ml steel reactor is initially charged with toluene (50.0 g), DMC catalyst (1500 ppm based on the total mass of starter and β-lactone) and adipic acid (2.92 g, 20.0 mmol, 1.00 eq.). The reactor is purged with N₂. β-Butyrolactone (17.1 g, 198 mmol, 9.90 eq.) is then continuously fed into the reactor over 120 min at 130° C. The mixture is stirred for a further 120 min at 130° C. Volatile components are subsequently removed under vacuum. The molecular weight is analyzed by gel permeation chromatography (GPC) in THF. The conversion is determined by means of ¹H NMR analysis.

### Comparative Example 1: Preparation of a Polyester from β-Butyrolactone Using DMC Catalysis and Hydroxy-Functionalized Starter (Octane-1,8-Diol)

The polymerization is effected analogously to example 1. As starter, adipic acid is replaced by octane-1,8-diol in identical mass and molar proportions.

### Example 2: Preparation of a Polyester from β-Butyrolactone Using DMC Catalysis and Carboxylic Acid-Functionalized Starter (Adipic Acid)

A 300 ml steel reactor is initially charged with toluene (50.0 g), DMC catalyst (2000 ppm based on the total mass of starter and β-lactone) and adipic acid (5.84 g, 40.0 mmol, 1.00 eq.). The reactor is purged with N₂. β-Butyrolactone (14.1 g, 164 mmol, 4.10 eq.) is then continuously fed into the reactor over 120 min at 130° C. The mixture is stirred for a further 120 min at 130° C. Volatile components are subsequently removed under vacuum. The molecular weight is analyzed by gel permeation chromatography (GPC) in THF. The conversion is determined by means of ¹H NMR analysis.

### Comparative Example 2: Preparation of a Polyester from β-Butyrolactone Using DMC Catalysis and Hydroxy-Functionalized Starter (Octane-1,8-Diol)

The polymerization is effected analogously to example 3. As starter, adipic acid is replaced by octane-1,8-diol in identical mass and molar proportions.

### Example 3: Preparation of a Polyester from β-Propiolactone Using DMC Catalysis and Carboxylic Acid-Functionalized Starter (Adipic Acid)

A 300 ml steel reactor is initially charged with THF (50.0 g), DMC catalyst (3000 ppm based on the total mass of starter and β-lactone) and adipic acid (2.92 g, 20.0 mmol, 1.00 eq.). The reactor is purged with N₂. β-Propiolactone (17.1 g, 237 mmol, 11.9 eq.) is then continuously fed into the reactor over 120 min at 130° C. The mixture is stirred for a further 120 min at 130° C. Volatile components are subsequently removed under vacuum. The molecular weight is analyzed by gel permeation chromatography (GPC) in THF. The conversion is determined by means of ¹H NMR analysis.

### Comparative Example 3: Preparation of a Polyester from β-Propiolactone Using DMC Catalysis and Hydroxy-Functionalized Starter (Octane-1,8-Diol)

The polymerization is effected analogously to example 1. As starter, adipic acid is replaced by octane-1,8-diol in identical mass and molar proportions.

### Example 4: Preparation of a Polyester from β-Propiolactone Using DMC Catalysis and Carboxylic Acid-Functionalized Starter (Adipic Acid)

A 300 ml steel reactor is initially charged with THF (50.0 g), DMC catalyst (3000 ppm based on the total mass of starter and β-lactone) and adipic acid (5.84 g, 40.0 mmol, 1.00 eq.). The reactor is purged with N₂. β-Propiolactone (14.1 g, 196 mmol, 4.90 eq.) is then continuously fed into the reactor over 120 min at 130° C. The mixture is stirred for a further 120 min at 130° C. Volatile components are subsequently removed under vacuum. The molecular weight is analyzed by gel permeation chromatography (GPC) in THF. The conversion is determined by means of ¹H NMR analysis.

### Comparative Example 4: Preparation of a Polyester from β-Propiolactone Using DMC Catalysis and Hydroxy-Functionalized Starter (Octane-1,8-Diol)

The polymerization is effected analogously to example 3. As starter, adipic acid is replaced by octane-1,8-diol in identical mass and molar proportions.

### Example 5: Solvent-Free Preparation of a Polyester from β-Propiolactone Using DMC Catalysis and Carboxylic Acid-Functionalized Starter in a Batch Process (Adipic Acid)

A 300 ml steel reactor is initially charged with DMC catalyst (3000 ppm based on the total mass of starter and β-lactone), adipic acid (14.6 g, 99.9 mmol, 1.00 eq.) and β-propiolactone (35.4 g, 491 mmol, 4.91 eq.). The reactor is purged with N₂. The mixture is stirred for a further 240 min at 130° C. Volatile components are subsequently removed under vacuum. The molecular weight is analyzed by gel permeation chromatography (GPC) in THF. The conversion is determined by means of ¹H NMR analysis.

### Example 6: Preparation of a Polyester from β-Propiolactone Using DMC Catalysis and Carboxylic Acid-Functionalized Starter (Citric Acid)

A 300 ml steel reactor is initially charged with THF (50.0 g), DMC catalyst (3000 ppm based on the total mass of starter and β-lactone) and citric acid (3.84 g, 20.0 mmol, 1.00 eq.). The reactor is purged with N₂. β-Propiolactone (16.2 g, 224 mmol, 11.2 eq.) is then continuously fed into the reactor over 120 min at 130° C. The mixture is stirred for a further 120 min at 130° C. Volatile components are subsequently removed under vacuum. The molecular weight is analyzed by gel permeation chromatography (GPC) in THF. The conversion is determined by means of ¹H NMR analysis.

### Example 7: Preparation of a Polyester from β-Propiolactone Using DMC Catalysis and Carboxylic Acid-Functionalized Starter (Terephthalic Acid)

A 300 ml steel reactor is initially charged with THF (50.0 g), DMC catalyst (3000 ppm based on the total mass of starter and β-lactone) and terephthalic acid (3.32 g, 20.0 mmol, 1.00 eq.). The reactor is purged with N₂. β-Propiolactone (16.7 g, 231 mmol, 11.6 eq.) is then continuously fed into the reactor over 120 min at 130° C. The mixture is stirred for a further 120 min at 130° C. Volatile components are subsequently removed under vacuum. The molecular weight is analyzed by gel permeation chromatography (GPC) in THF. The conversion is determined by means of ¹H NMR analysis.

TABLE 1
Preparation of polyesters from β-lactones using DMC catalysis

| | | H-funct. starter | | x(cat) | m(bPL)/m | | Mₙ | | X(lactone) |
|---|---|---|---|---|---|---|---|---|---|
| No. | Lactone | substance | Catalyst | [ppm] | (starter) | Solvent | [g/mol] | PDI | [%] |
| Ex. 1 | bBL | adipic acid | DMC | 1500 | 5.84 | toluene | 970 | 1.02 | 93 |
| Comp. | bBL | octane-1,8-diol | DMC | 1500 | 5.84 | toluene | octane-1,8-diol, | multimodal | 100 |
| ex. 1 | | | | | | | 2300, 4500 ^{a)} | | |
| Ex. 2 | bBL | adipic acid | DMC | 2000 | 2.42 | toluene | 610 | 1.03 | 93 |
| Comp. | bBL | octane-1,8-diol | DMC | 2000 | 2.42 | toluene | octane-1,8-diol, | multimodal | 100 |
| ex. 2 | | | | | | | 2000, 4500 ^{a)} | | |
| Ex. 3 | bPL | adipic acid | DMC | 3000 | 5.84 | THF | 1260 | 1.02 | 94 |
| Comp. | bPL | octane-1,8-diol | DMC | 3000 | 5.84 | THF | octane-1,8-diol, | multimodal | 91 |
| ex. 3 | | | | | | | 2300, 3700 ^{a)} | | |
| Ex. 4 | bPL | adipic acid | DMC | 3000 | 2.42 | THF | 790 | 1.06 | 90 |
| Comp. | bPL | octane-1,8-diol | DMC | 3000 | 2.42 | THF | octane-1,8-diol, | multimodal | 96 |
| ex. 4 | | | | | | | 1900, 4000 ^{a)} | | |
| Ex. 5 | bPL | adipic acid | DMC | 3000 | 2.42 | — | 580 | 1.08 | 99 |
| Ex. 6 | bPL | citric acid | DMC | 3000 | 3.76 | THF | 1260 | 1.07 | 95 |
| Ex. 7 | bPL | terephthalic acid | DMC | 3000 | 5.03 | THF | 1290 | 1.06 | 95 |

^{a)} A multimodal molecular weight distribution is observed. Non-converted starter was identified here. The peak maxima of the polyester signals observed are also given.

1. A process for preparing a polyester comprising reacting an H-functional starter substance with a lactone in the presence of a catalyst;
wherein the H-functional compound has one or more free carboxyl groups;
wherein the lactone comprises a 4-membered-ring lactone; and
wherein the catalyst comprises a Brønsted acid or a double metal cyanide (DMC) catalyst.

2. The process as claimed in claim 1, wherein the 4-membered-ring lactone comprises propiolactone, β-butyrolactone, diketene, preferably propiolactone and β-butyrolactone, or a mixture thereof.

3. The process as claimed in claim 1, comprising:
i) initially charging the H-functional starter substance and optionally the catalyst to form a mixture i);
ii) adding the lactone to the mixture i).

4. The process as claimed in claim 3, wherein the lactone is added continuously or stepwise to the mixture i) in step ii).

5. The process as claimed in claim 1, comprising:
(a) initially charging the H-functional starter substance, the lactone and optionally the catalyst to form a mixture (a);
(b) reacting the mixture (a) to afford the polyester.

6. The process as claimed in claim 1, wherein the H-functional starter substance having one or more free carboxyl groups comprises a monobasic carboxylic acid, a polybasic carboxylic acid, a carboxyl-terminated polyester, a carboxyl-terminated polycarbonate, a carboxyl-terminated polyether carbonate, a carboxyl-terminated polyether ester carbonate polyols and a carboxyl-terminated polyether or a mixture thereof.

7. The process as claimed in claim 1, wherein the H-functional starter substance having one or more free carboxyl groups comprises methanoic acid, ethanoic acid, propanoic acid, butanoic acid, pentanoic acid, hexanoic acid, heptanoic acid, octanoic acid, decanoic acid, dodecanoic acid, tetradecanoic acid, hexadecanoic acid, octadecanoic acid, lactic acid, fluoroacetic acid, chloroacetic acid, bromoacetic acid, iodoacetic acid, difluoroacetic acid, trifluoroacetic acid, dichloroacetic acid, trichloroacetic acid, oleic acid, salicylic acid, benzoic acid, oxalic acid, malonic acid, succinic acid, glutaric acid, adipic acid, pimelic acid, suberic acid, azelaic acid, sebacic acid, citric acid, trimesic acid, fumaric acid, maleic acid, 1,10-decanedicarboxylic acid, 1,12-dodecanedicarboxylic acid, phthalic acid, isophthalic acid, terephthalic acid, pyromellitic acid and trimellitic acid, acrylic acid, methacrylic acid, or a mixture thereof.

8. The process as claimed in claim 1, wherein the catalyst comprises a double metal cyanide (DMC) catalyst.

9. The process as claimed in claim 8, wherein the double metal cyanide (DMC) catalyst comprises an organic complex ligand, wherein the organic complex ligand comprises tert-butanol, 2-methyl-3-buten-2-ol, 2-methyl-3-butyn-2-ol, ethylene glycol mono-tert-butyl ether and 3-methyl-3-oxetanemethanol, or a mixture thereof.

10. The process as claimed in claim 1, wherein the process is performed without addition of a solvent.

11. The process as claimed in claim 1, wherein the molar ratio of the lactone to the H-functional starter substance is from 1:1 to 30:1.

12. A polyester obtained by the process of claim 1.

13. The polyester as claimed in claim 12, wherein the polyester has a polydispersity index of ≤1.15 as determined by means of gel permeation chromatography.

14. A coating composition or adhesive composition comprising the polyester of claim 12.
